(19) United States
(12) Patent Application Publication
(10) Pub. No.: US 2007/0249193 A1
(43) Pub. Date: Oct. 25, 2007

(54) Universal hybrid electrical/fiber optic insert cap and hybrid connector and methods

(75) Inventors: Venkata R. Penumatcha, Plano, TX (US); Vincent A. Wouters, McKinney, TX (US); Rodney M. Flower, Richardson, TX (US)

Correspondence Address: DOCKET CLERK, P.O. DRAWER 800889, DALLAS, TX, 75380, US

(73) Assignee: Applied Optical Systems, Inc., Plano, TX (US)

(21) Appl. No.: 11/732,491

(22) Filed: Apr. 3, 2007

Related U.S. Application Data
(60) Provisional application No. 60/788,963, filed on Apr. 4, 2006.

(51) Int. Cl. H01R 13/44

(52) U.S. Cl. 439/125

(57) ABSTRACT

Blank insert caps (pin/socket type) for use in a connector/assembly are partially manufactured or pre-formed to a generic or universal state having a plurality of prospective terminal/contacts. Minimal subsequent processing (performed when desired) configures the blank insert cap into a hybrid insert cap having a desired combination of electrical and fiber optic pin terminals (in the case of pin-style insert cap) or electrical and fiber optic socket terminals (in the case of socket-style insert caps). The blank insert caps include partially formed structures that, when further processed by removal of specific material, are configured into a receptacle for receiving the desired terminal.

### CROSS-REFERENCE TO RELATED APPLICATION

This application claims priority under 35 U.S.C. 119(e) to U.S. provisional Application Ser. No. 60/788,963, filed on Apr. 4, 2006, and which is incorporated herein by reference.

### TECHNICAL FIELD

The present invention relates generally to electrical fiber optic connectors, and more particularly to universal hybrid electrical/fiber optic insert cap for use in cable assemblies and connection systems.

### BACKGROUND

In the past, most power supply and data transmission needs were addressed exclusively using electrical signals and transmission media. Over time, however, electrical transmission technologies have—in many applications—given way to optical transmission technologies having superior performance characteristics. For example, extensive fiber optic networks have been developed for providing long-range signal transmission in a manner that is more efficient and effective than a comparable electrical network.

As the prevalence of optical transmission technologies has increased, modern data processing and transmission systems have been modified and designed to utilize both electrical and optical technologies. Frequently, therefore, systems may rely upon electrical signal transmission, optical signal transmission, or some form of signal transmission (including power) that combines or converts both electrical and optical signals. Commonly, certain signal transmission elements have taken to integrating electrical and optical media where possible, to reduce cost and improve efficiency. Consider, for example, the increasing introduction and use of cabling that integrates both optical and electrical transmission media within a single cable. Standard and user-configurable cabling having both optical and electrical channels is growing in availability and utilization. Correspondingly, the interconnection of systems must also address the presence or utilization of both electrical and optical transmission media.

As such, a need exists for robust connectors and receptacles capable of carrying both electrical and optical signal conductors. Until recently, design constraints and cost concerns for most commercial and consumer applications have militated in favor of separate connectors for optical and electrical elements. Under conventional schemes, optical and electrical connections have often had disparate, or even incompatible, connection requirements. In certain industrial and military applications, however, there exist conventional hybrid connectors—ones that integrate both electrical and optical connections within a single plug or receptacle. Unfortunately, however, most such conventional hybrid connectors have not been produced in a manner that is commercially viable for high-volume, low-cost applications.

Generally, conventional hybrid connectors have been application-specific, having a fixed channel configuration related to a single cabling topology—i.e., the positioning and ratio of optical and electrical lines within a give cable/connector. Thus, a conventional hybrid connector designed for use with one type of cable would not be compatible for use with a cable having a different topology. Moreover, if a modification is needed to a conventional hybrid cable design (during the design process or in the field) which requires an increase or decrease in the number/ratio of electrical/optical connections, the connector must be substantially modified. Conventional hybrid connectors are commonly produced in a custom or semi-custom manner, where the connector design is machined or molded in its final configuration=13 often due, at least in part, to the high level of precision needed for reliable optical connection alignment. As a result, the manufacturing of a new insert cap/body with the correct topology is usually required—taking many weeks or even months for production and the subsequent connector retrofit. Thus, with such conventional approaches, connectors are typically not produced in a manner compatible with high-volume mass production.

Accordingly, there exists a need for new connector components and systems that provide hybrid optical/electrical connectors—readily adaptable to a variety of configurations—produced in a cost-efficient, easily scalable manner that is compatible with utilization in any application, including military, commercial and consumer end-use applications. Such components and systems will reduce lead times in manufacturing.

### SUMMARY

In accordance with one embodiment, there is provided a multichannel hybrid connector insert cap for use in a connector. The insert cap includes a first end having a surface, a second end having a surface, and a body. The body includes insulative material and a plurality of sections. Each section is configured with at least one dimensional aspect operable for receiving a portion of an electrical terminal and at least one dimensional aspect operable for receiving a portion of a fiber optic terminus. Each section is further configurable to receive the electrical terminal when a first predetermined amount of material is removed from the section or to receive the fiber optic terminus when a second predetermined amount of material is removed from the section. There is also provided a method of forming the above=13 described insert cap.

In another embodiment, there is provided a hybrid connector insert cap having a first side, a second side, and a body. The body has a plurality of portions, with each portion initially having a universal structure operable for receiving an electrical terminal when a first predetermined amount of material is subsequently removed from the portion and to receive a fiber optic terminal when a second predetermined amount of material is subsequently removed from the portion.

In yet another embodiment, there is provided a connector having a connector housing and an insert cap positioned within the connector housing. The insert cap includes a plurality of terminal sections, including a first terminal positioned within a first one of the plurality of terminal sections, with the first terminal coupled to a first conductor, and including a second terminal positioned within a second one of the plurality of terminal sections, with the second terminal coupled to a second conductor. A third one of the plurality of terminal sections is configured as a universal terminal section and does not include a terminal therein.

In another embodiment, there is provided a method of forming a custom hybrid insert cap from a blank or universal insert cap for use in a connector. A blank insert cap having a plurality of terminal sections is provided and a connector configuration for the custom hybrid insert cap is determined. Based on the determined connector configuration, material is removed from one or more selected first terminal sections to form one or more electrical terminal receptacles operable for receiving one or more electrical terminals, and material is removed from one or more selected second terminal sections to form one or more fiber optic terminal receptacles operable for receiving fiber optic terminals.

Other technical features may be readily apparent to one skilled in the art from the following figures, descriptions, and claims.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates one embodiment of a connector assembly in accordance with the present invention;

FIGS. 2A-2C illustrate various embodiments of systems utilizing connectors in accordance with the present invention;

FIGS. 3A-3C illustrate various views of one embodiment of a pin-style insert cap in accordance with the present invention;

FIG. 4A is a cut-way cross-section view of one section of the pin-style insert cap shown in FIGS. 3A-3C;

FIG. 4B is a cut-way cross-section view illustrating the same cross-section shown in FIG. 4A after processing to produce an aperture configured to receive an electrical pin terminal;

FIG. 4C is a cut-way cross-section view illustrating the same cross-section shown in FIG. 4A after processing to produce an aperture configured to receive a fiber optic pin terminal;

FIGS. 5A-5C illustrate various views of one embodiment of a socket-style insert cap in accordance with the present invention;

FIG. 6A is a cut-way cross-section view of one section of the socket-style insert cap shown in FIGS. 5A-5C;

FIG. 6B is a cut-way cross-section view illustrating the same cross-section shown in FIG. 4A after processing to produce an aperture configured to receive an electrical socket terminal;

FIG. 6C is a cut-way cross-section view illustrating the same cross-section shown in FIG. 4A after processing to produce an aperture configured to receive a fiber optic socket terminal;

FIGS. 7A-7C illustrate various views of one embodiment of an insert body;

FIGS. 8A-8B illustrate two views of one embodiment of a rear seal housing;

FIGS. 9A-9B illustrate two views of an insulative electrical pin insert seal;

FIG. 10 illustrates one embodiment of a connector assembly in accordance with the present invention; and

FIGS. 11A and 11B illustrate a process for manufacturing a blank insert cap and process for manufacturing a custom hybrid insert cap, in accordance with the present invention.

### DETAILED DESCRIPTION

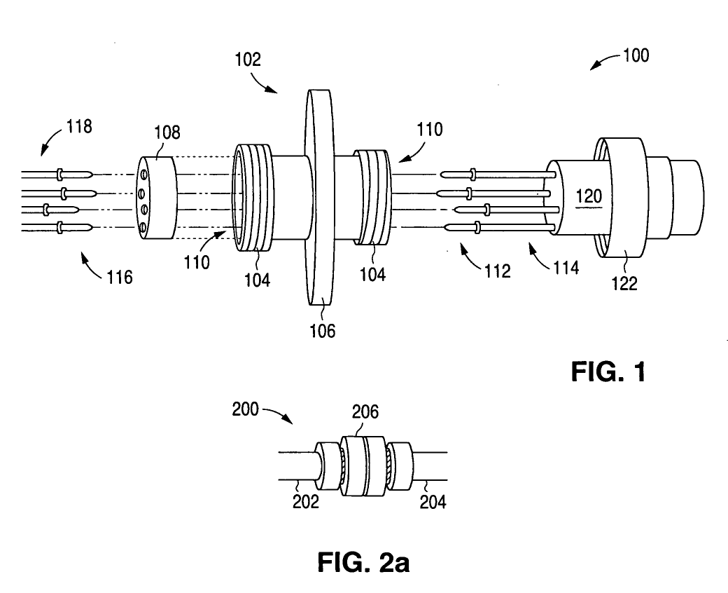

Certain aspects and embodiments of the system of the present invention are described in greater detail beginning with reference to FIG. 1, which depicts an illustrative embodiment of a simplified connector assembly 100 in accordance with the present invention. The assembly 100 includes a connector housing 102, which may be provided in a number of configurations adapted to specific end-use applications. For example, the connector housing 102 may include an engagement feature 104—such as either a “male” or “female” screw or snap-lock feature—disposed on either or both ends of the housing 102. Alternatively, or in addition to the feature(s) 104, the housing 102 may include a mounting feature 106—such as a flange or bracket—disposed or formed along the housing 102.

In certain embodiments, the connector 100 may be provided as a cable-to-cable connector or a cable-terminating connector. In such embodiments, the engagement features 104 may be utilized to provide necessary intercoupling. In embodiments where the connector 100 is provided in a receptacle or socket configuration, one or more engagement features 106, such as a flange, may be used to provide for mounting of the connector 100 in—for example—a wall socket. The housing 102 may be provided with a number of alternative engagement features adapted to specific end-use applications in accordance with the present invention.

The connector 100 includes an insert cap 108. The formation, configuration and assembly of insert cap 108 will be described in greater detail hereinafter. The insert cap 108 is disposed—depending upon the application and the type of connector 100 desired—within a recess or channel 110 of the housing 102, in either a permanent, fixed, or adjustable manner. In some embodiments, for example, the insert cap 108 may be formed as an integral part of an injected molded plastic housing 102. In other embodiments, the insert cap 108 may be secured within the housing 102 permanently (e.g., epoxy, etc.) or adjustably secured (e.g., screws attaching the insert cap 108 to an internal flange or bracket within the channel 110 or to other components therein, not shown). Other similar arrangements and various combinations thereof are further comprehended by the present invention.

The insert cap 108 is formed or assembled to receive and secure a plurality of termini or terminals 112 from cable elements 114, for eventual interconnection to a plurality of corresponding termini or terminals 116 from cable elements 118. The cable elements 114, 118 may include a variety or combination of electrical wires and/or fiber optic lines. Depending upon the particular application, cable elements 114 may be introduced into the housing 102 individually, or bundled together in one or more combined cables.

As depicted in FIG. 1, the cable elements 114 are introduced into the housing 102 from a single combined cable 120. The cable 120 may include its own engagement feature 122 (e.g., a screw assembly) adapted to engage with one of the features 104 or 106 along the housing 102 to secure and hold the cable 120 and the cable elements 114 in a fixed relationship to the insert cap 108. In other embodiments, one of the features 104 on the housing 102 may be formed or adapted to hold and secure the cable 120 in fixed relationship to the insert cap 108. For example, a feature 104 at the end of the housing 102 may include a clamp, clamping mechanism or tine assembly that partially penetrates an outer insulation or covering of the cable 120.

Although not depicted in FIG. 1, connector 100 may include one or more intermediary elements (not shown), such as hermetic seals or insulating gaskets, which either adjoin or surround the elements 114 within the connector 100. Such intermediary elements may be substantially different from the insert cap 108 in structure and composition or, depending upon the embodiment, may be similar thereto. For example, a flexible seal or gasket—similar in configuration to, but different in composition from, the insert cap 108—may be provided within the connector 100 in conjunction with the insert cap 108 to provide additional functionality, such as shock resistance or environmental insulation. Some other intermediary elements in accordance with the present invention are also presented and described hereinafter in relation to different figures.

Once an insert cap 108 is secured within the housing 102 and the termini 112 have been successfully and securely engaged within the insert cap 108, the connector 100 forms a complete connector assembly that is suitable for facilitating a secure intercoupling of the termini 112 to various corresponding termini 116. Depending upon the application, the connector 100 may be connected to another connector or receptacle housing the termini 116. In other embodiments, such as where the connector 100 serves as a receptacle connection for the cable 120, the termini 116 and cable elements 118 may include some incumbent transmission elements (e.g., emanating from within a wall) that are introduced into the housing 102 and the insert cap 108 directly or individually, without having their own separate connector. Other similar configurations, and various combinations thereof, are further comprehended by the present invention.

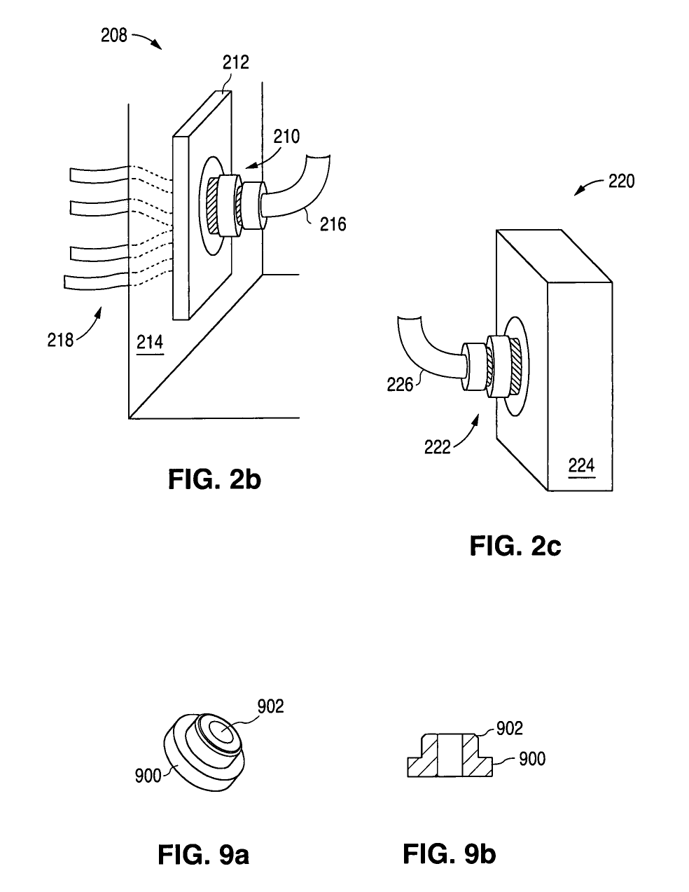

Referring now to FIGS. 2A-2C, several illustrative embodiments of end-equipment applications incorporating the connector architecture of the present invention are depicted. In FIG. 2A, a cable assembly 200 includes cable segments 202 and 204. The assembly 200 further includes a connector 206 in accordance with the present invention, similar in structure or configuration to the connector 100 of FIG. 1. As will be appreciated, the assembly 200 is representative of different cable-to-cable intercouplings, all of which may benefit from the present invention.

In similar fashion, the connector architecture of the present invention may be provided in an outlet topology, as illustratively depicted in reference now to an outlet assembly 208 of FIG. 2B. The outlet assembly 208 includes a connector 210 in accordance with the present invention, similar in structure or configuration to the connector 100 of FIG. 1. The connector 210 may be mounted to a socket plate or panel 212 which is mounted to a wall 214 or, alternatively, may be directly mounted to the wall 214. The connector 210 provides secure coupling of cable elements of a cable 216 to corresponding cable elements 218 (e.g., electrical wires, fiber optic lines) that are accessible from within the wall 214. This embodiment is representative of a wide variety of outlet-type applications. For example, the cable 216 may connect an associated personal computer with power, communications, or multimedia resources available via cable elements 218.

Referring now to FIG. 2C, the connector architecture of the present invention may also be provided in a socket topology, as illustratively depicted in reference to a socket assembly 220 of FIG. 2C. The socket assembly 220 includes a connector 222 in accordance with the present invention, similar in structure or configuration to the connector 100 of FIG. 1. The connector 222 may be mounted to some electronic component, device or system 224 as a socket—providing secure coupling of cable elements of cable 226 to signal processing or transmission sub-systems within component, device or system 224. This embodiment is representative of a wide variety of socket-type applications, in which the connector architecture of the present invention provides secure connection between various electronics systems or components. For example, the component, device or system 224 may be a personal computer or a server, a communications router or antenna system, or some electromechanical system or other electronic device performing a prescribed function.

Certain aspects of the present invention are addressed to the need for “genderability” of connectors—i.e., the ability to provide a connection in either a male (i.e., pin) or female (i.e., socket) topology. The need for genderability generally arises from the conventional standard of providing “intrinsically safe” electrical connections. “Intrinsically safe” electrical conventions usually dictate that passive, uncharged connection elements may be provided in “pin” or “male” form, while live charged connection elements are provided within “socket” or “female” form—so as to prevent inadvertent contact with another connection or object.

The present invention recognizes that a universal or configurable connector should provide the ability to present any given termini in either a pin or socket orientation. The present invention further recognizes that—although such considerations have been addressed in some strictly electrical connector systems—genderability has typically not previously been of concern in fiber-optic connectors. Thus, in order to successfully and efficiently provide a universal and configurable connector system, genderability should be taken into account and provided for both electrical and optical connections.

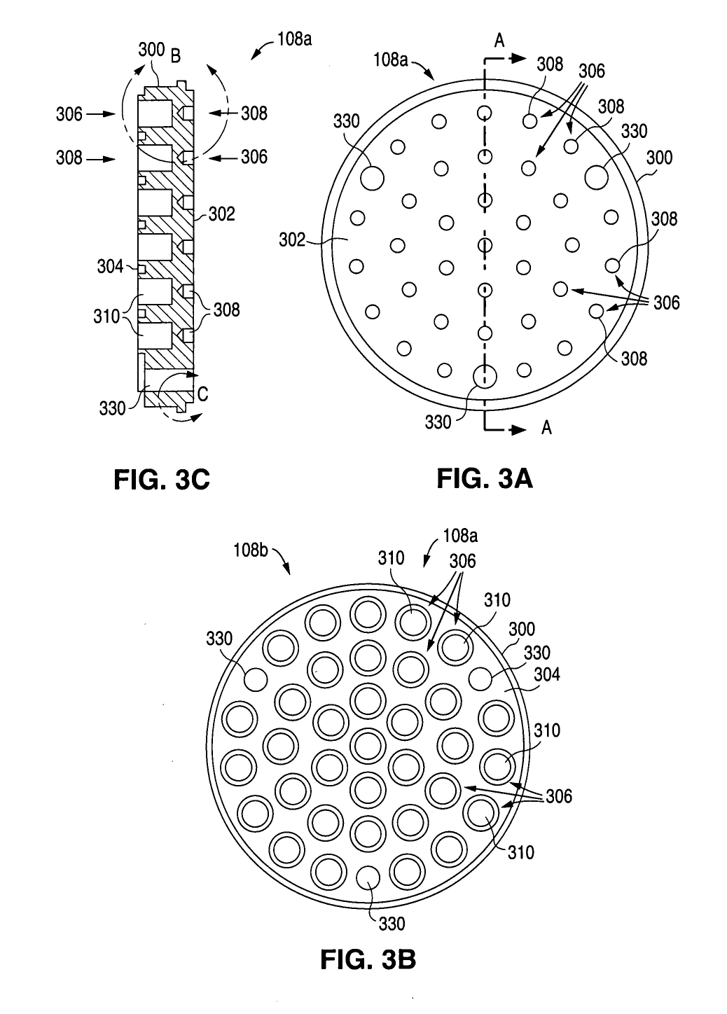

Now referring to FIGS. 3A-3C, there are illustrated various views of an insert cap 108a of a first type. In this configuration, the insert cap 108a is formed or configured to receive pin (i.e., male) terminals, and will be referred to hereinafter as a “pin” or “pin-style” insert cap.

With reference to these FIGURES, the pin insert cap 108a includes a body 300 and a first surface 302 and a second surface 304. FIGS. 3A and 3B are front views of the first surface 302 and the second surface 304, respectively, of the pin insert cap 108a. FIG. 3C is a cross-sectional view taken along line A-A of FIG. 3A.

The pin insert cap 108a includes a plurality of adjacent sections or portions 306, as shown (may be referred to as “terminal sections”). Each section or portion 306, as shown, is formed or configured to be a “universal” configuration or structure that is further configurable (as described later) into a “specific” configuration or structure for receiving either an electrical pin terminal (not shown) or a fiber optic pin terminus (not shown). Each section 306 includes a first bore or cavity 308 extending from the first surface 302 to a predetermined depth in the body 300. Each section 306 includes a second bore or cavity 310 extending from the second surface 304 to a predetermined depth in the body 300. The size, shape and depth of the bore 306 is formed to provide the proper mating surface/structure for either a fiber optic or electrical pin terminal—depending on which type of terminal will be utilized for a given section 306. Similarly, the size, shape and depth of the bore 310 is formed to provide the proper mating surface/structure for either a fiber optic or electrical pin terminal—depending on which type of terminal will be utilized for a given section 306.

In one embodiment, the diameter of the bore 308 is chosen such that standardized electrical pin and socket terminals (i.e., electrical contacts) will fit therein. For example, in accordance with military specification M39029, terminals for 16, 18, 20 and 22 gauge conductors are a standard size and will fit within the bore 308. In other embodiments, the size of the bore 308 may different depending on the desired size of the electrical pins and contacts.

It will be understood that the term “blank” may also be used to refer to the insert cap 108a in the “universal” configuration. A blank insert cap operates as the base component which is further processed to produce a custom or specific configured insert cap.

As shown in FIGS. 3A-3C, the body 300 of the pin insert cap 108a has a circular or cylindrical shape with predetermined diameter and thickness. It will be understood that different shapes (e.g., square) and dimensions may be utilized. Further, the pin insert cap 108a is shown in one embodiment as including thirty-four (34) adjacent sections or portions 306 capable of being further processed or modified for the desired connections/terminals. The pin insert cap 108a may include any number of sections 306 for eventual utilization as terminal receptors.

The insert cap body 300 further includes one or more holes or apertures 330 for receiving a connector or connection mechanism (e.g, screw) therethrough for connecting or attaching the insert cap 108a to another structure or component, such as an insert body (described further below) and/or a seal housing.

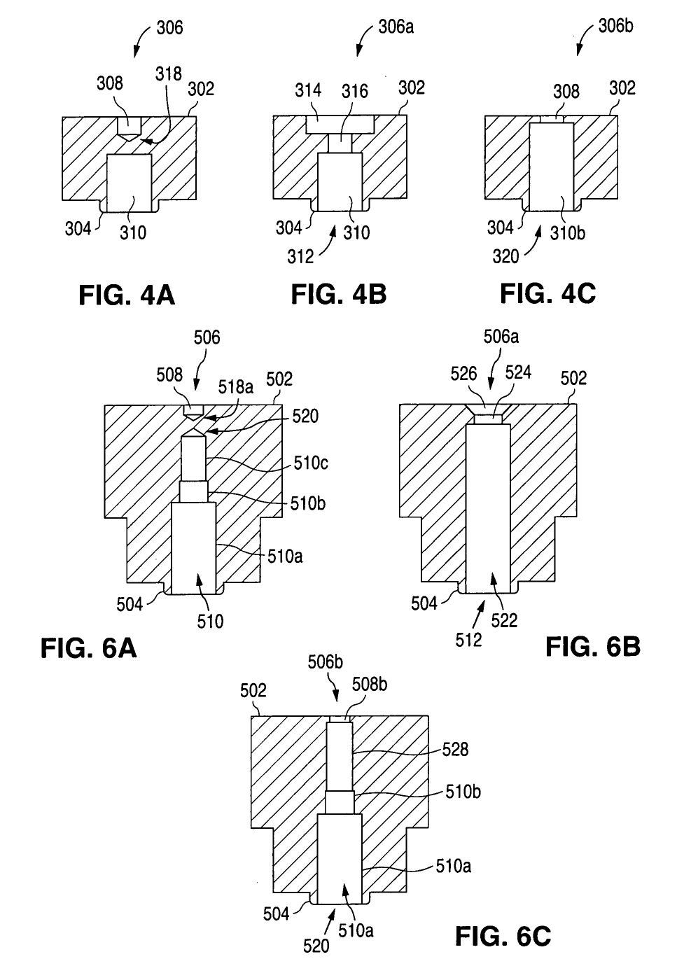

Now referring to FIG. 4A, there is shown a more detailed cross-sectional structural view of the section or portion 306 of the pin insert cap 108a with illustration of the bores 308, 310. In this structural configuration, the section 306 provides a “universal” or “generic” configuration (or “blank”), and may be referred to as a “universal terminal section” or by similar language. Such configuration provides the benefit that some initial or intermediate features/structure of the final structure have been pre-formed (molded, machined, etc.) to produce a generic or universal pin insert cap 108a (i.e., formed to an intermediate stage). Such blank pin insert caps 108a may be manufactured in bulk and maintained in inventory until the final desired configuration of the insert cap 108a is determined. When the desired configuration is determined, selected sections 306 are formed to provide a specific predetermined structure—to receive either a fiber optic pin terminal or an electrical pin terminal. Other sections 306 may be left unchanged (i.e., blank configuration)—which are spares or unused. As will be appreciated, the spare or extra sections 306 are present for future use, if needed.

Now referring to FIG. 4B, there is shown a detailed cross-sectional view of a section 306a of the pin insert cap 108a produced after processing/modification of the section 306 (shown in FIG. 4A) to form the new section 306a that is operable for receiving an electrical pin terminal. The bore 310 is present, however, additional material has been removed to form an aperture 312 through the body 300 that includes the bore 310, a bore 314 and an intermediate bore 316, as shown. The bores 310, 312, 316 each have diameters that are concentric with a longitudinal axis of the aperture 312 extending through the body 300.

The material may be removed in one or more steps using one or more drilling tools or other removal techniques. In one embodiment, a single drilling tool is utilized to form the bores 314 and 316 in a single step. This material removal may be accomplished by drilling/counterboring from the first side 302 of the body 300. Again referring to FIG. 4A, the section 306 in the universal or generic configuration of the section 306 includes a pilot structure 318. The pre-formed pilot structure 318 and/or the bore 310 each may function to guide or pilot the drilling tool at the proper location—without the need for a special or complex alignment mechanism or technique.

As will be appreciated, the bore 314 is optional, and may be included to provide a recess or receptacle for receiving a seal or insulator (not shown) when it is desired to insulate or seal a portion of the electrical pin extending outward from the body 300. When bore 314 is not utilized, the intermediate bore 318 uniformly extends from the surface 302 to the bore 310.

Now referring to FIG. 4C, there is shown a detailed cross-sectional view of a section 306b of the pin insert cap 108a produced after processing/modification of the section 306 (shown in FIG. 4A) to form the new section 306b that is operable for receiving a fiber optic pin termini. Only a portion of the bore 308 is present as a result of the removal of additional material to form an aperture 320 through the body 300 that includes a portion of the bore 308 and a bore 310b. The remaining portion of the bore 308 and the bore 310b each have diameters that are concentric with a longitudinal axis of the aperture 320 extending through the body 300.

The material may be removed in one or more steps using one or more drilling tools or other removal techniques. In one embodiment, a single drilling tool is utilized to form the bore 310b, which is a deeper extension of the original bore 310, in a single step. This material removal may be accomplished by drilling from the second side 304 of the body 300. The original bore 310 functions to guide or pilot the drilling tool at the proper location—without the need for a special or complex alignment mechanism or technique.

Each of the plurality of sections 306 may be formed or configured—in a subsequent process—into either the structure/configuration of the section 306a (FIG. 4B) or the section 306b (FIG. 4C), or left generic or universal (blank). For example, an insert body 108a with thirty-four possible connections may have, after further processing to produce the final product, a 24/6/4 configuration, where there are twenty-four sections operable for fiber optic pin terminals, six sections operable for electrical pin terminals, and four sections left unchanged from the original configuration (for use as spares). Other numbers and combinations may be chosen depending on the desired application.

As will be appreciated, the bore 308 of the blank universal pin insert cap 108a shown in FIG. 4A may be alternatively constructed to extend through the body 300 all the way to the bore 310 resulting in an aperture or hole therethrough. However, in some applications, such as when some sections are not utilized (spares), this may be undesirable due to the failure to seal the connector housing from environmental conditions when unconnected. Thus, the bore 308 is formed to extend to a depth that does not result in a passage between the bore 308 and the bore 310.

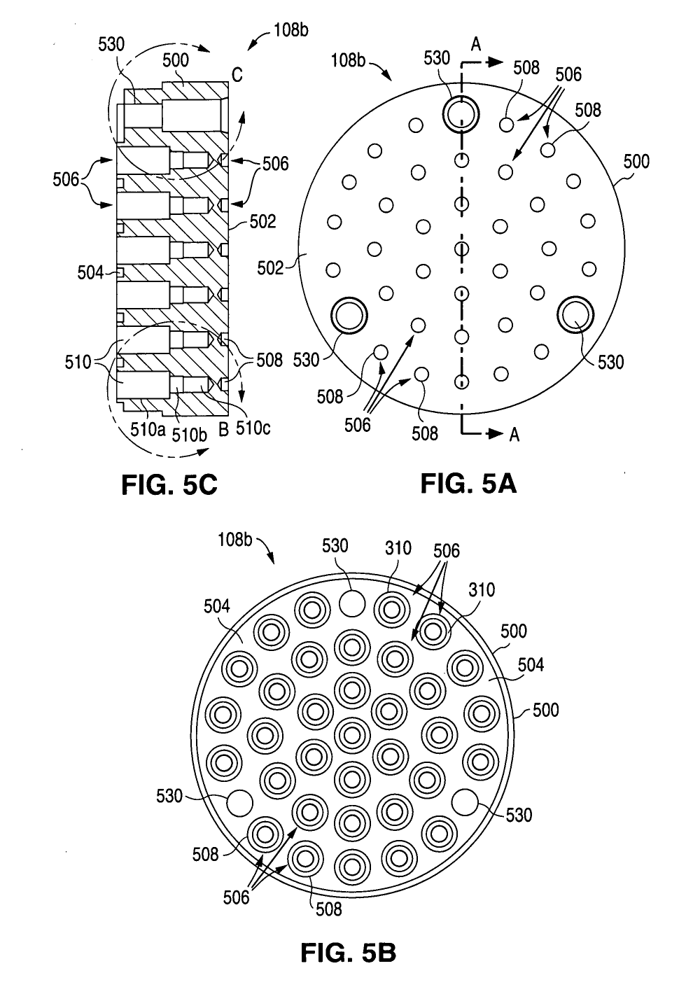

Now referring to FIGS. 5A-5C, there are illustrated various views of an insert cap 108b of a first type. In this configuration, the insert cap 108b is formed or configured to receive socket (i.e., female) terminals, and will be referred to hereinafter as a “socket” or “socket-style” insert cap.

With reference to these FIGURES, the socket insert cap 108b includes a body 500, a first surface 502 and a second surface 504. FIGS. 5A and 5B are front views of the first surface 502 and the second surface 504, respectively, of the socket insert cap 108b. FIG. 5C is a cross-sectional view taken along line A-A of FIG. 5A.

Similar to the pin insert cap 108a, the socket insert cap 108b includes a plurality of adjacent sections or portions 506, as shown. Each section or portion 306, as shown, is formed or configured to be a universal configuration or structure that is further configurable (as described later) into a “specific” configuration or structure for receiving either an electrical socket terminal (not shown) or a fiber optic socket terminus (not shown). Each section 506 includes a first bore or cavity 508 extending from the first surface 502 to a predetermined depth in the body 500. Each section 506 includes a second bore or cavity 510 extending from the second surface 304 to a predetermined depth in the body 500. The size, shape and depth of the bore 508 is formed to provide the proper mating surface/structure for either a fiber optic or electrical socket terminal—depending on which type of terminal will be utilized for a given section 508. Similarly, the size, shape and depth of the bore 510 is formed to provide the proper mating surface/structure for either a fiber optic or electrical socket terminal—depending on which type of terminal will be utilized for a given section 508.

As described above with respect to the insert caps 108a, the insert caps 108b may similarly be referred to as blanks when in the “universal” configuration (or first state).

As shown in FIGS. 5A-5C, the body 500 of the socket insert cap 108b has a circular or cylindrical shape with predetermined diameter and thickness. Different shapes (e.g., square) and dimensions may be utilized. Similar to pin insert cap 108a shown in FIGS. 3A-3C, the socket insert cap 108b is shown in one embodiment as including thirty-four (34) adjacent sections or portions 506 capable of being further processed or modified for the desired connections/terminals. The socket insert cap 108b may include any number of sections 506 for eventual utilization as terminal receptors.

The insert cap body 500 further includes one or more holes or apertures 530 for receiving a connector or connection mechanism (e.g, screw) therethrough for connecting or attaching the insert cap 108b to another structure or component, such as an insert body and/or a seal housing.

Now referring to FIG. 6A, there is shown a more detailed cross-sectional structural view of the section or portion 506 of the socket insert cap 108b with illustration of the bores 508, 510. In this structural configuration, the section 506 provides a “universal” or “generic” configuration (or “blank”) similar to the sections 306 in the pin insert cap 108a, but are instead for use with socket/female terminals (or at least as socket or female cap inserts for female “type” connectors). When the desired configuration is determined, selected sections 508 are formed to provide a specific predetermined structure—to receive either a fiber optic socket terminal or an electrical socket terminal. Other sections 508 may be left unchanged—which are spares or unused.

The bore 510 includes several sections—a first bore section 510a, a second bore section 510b and a third bore section 510c, as shown in FIG. 6A (and 5A).

Now referring to FIG. 6B, there is shown a detailed cross-sectional view of a section 506a of the socket insert cap 108b produced after processing/modification of the section 306 (shown in FIG. 4A) to form the new section 506a that is operable for receiving an electrical socket terminal. The section 506a includes a first bore section 522, a second bore section 524 and a third chamfer bore section 526. Additional material has been removed to form an aperture 512 through the body 500 that includes the bore sections 522, 524, 526, as shown. The bore sections 522, 524, 526 each have diameters that are concentric with a longitudinal axis of the aperture 512 extending through the body 500.

The material may be removed in one or more steps using one or more drilling tools or other removal techniques. In one embodiment, a drilling tool is utilized to form the bore 522 in a single step, and a drilling tool is utilized to form the bore 524 and the third chamfered bore section 526 in a step (one or two steps). This material removal may be accomplished by drilling/boring from the second side 504 of the body 500 and drilling/boring/chamfering from the first side 502, respectively. Again referring to FIG. 6A, the section 506 in the universal or generic configuration of the section 506 includes a pilot structure 518. The pre-formed pilot structure 518 and/or the bore 510a each may function to guide or pilot the drilling tool at the proper location—without the need for a special or complex alignment mechanism or technique.

As will be appreciated, chamfered portion of the bore 526 is optional, and may be included to provide a recess or receptacle for receiving/guiding a portion of a seal or insulator (not shown) used in conjunction with a corresponding electrical pin (see previous description) on a mating connector. When the chamfered portion is not utilized, the bore 526 may uniformly extend from the surface 502 to the bore 524.

Now referring to FIG. 6C, there is shown a detailed cross-sectional view of a section 506b of the socket insert cap 108b produced after processing/modification of the section 506 (shown in FIG. 6A) to form the new section 506b that is operable for receiving a fiber optic socket termini. Only a portion of the bore 508 is present as a result of the removal of additional material to form an aperture 520 through the body 500 that includes a portion of the bore 508, a bore 528 (which is an extension of the bored 510c of FIG. 6A), the bore 510a and the bore 510b. The remaining portion of the bore 508 and the bores 528, 510a and 510b each have diameters that are concentric with a longitudinal axis of the aperture 520 extending through the body 500.

The material may be removed in one or more steps using one or more drilling tools or other removal techniques. In one embodiment, a single drilling tool is utilized to form the bore 528, which is a deeper extension of the original bore 510c, in a single step. This material removal may be accomplished by drilling from the second side 504 of the body 500. The original bores 510a, 510b, 510c function to guide or pilot the drilling tool at the proper location—without the need for a special or complex alignment mechanism or technique.

As with the sections 306, each of the plurality of sections 506 may be formed or configured—in a subsequent process—into either the structure/configuration of the section 506a (FIG. 6B) or the section 506b (FIG. 6C), or left generic or universal (blank). Any number and combinations of each type may be chosen depending on the desired application.

As will be appreciated, the bores may be alternatively constructed in such a manner that they extend through the body 500 all the way resulting in an aperture or hole therethrough. As described earlier, this may be undesirable in the blank configuration due to the failure to seal the connector housing from environmental conditions when unconnected. Thus, the bores 508 and 510 are formed to extend to depths that do not result in a passage between the bore 508 and the bore 510 in the blank configuration.

In one embodiment, the diameter of the bores 508, 308 are chosen such that standardized electrical pin and socket terminals, or appropriate portions thereof, (i.e., electrical contacts) will fit therein. For example, in accordance with military specification M39029, terminals for 16, 18, 20 and 22 gauge conductors are of uniform size and will fit within such bores 508, 308. In other embodiments, the size of the bores 508, 308 may different depending on the desired size of the electrical pins and contacts.

As will be appreciated, in one embodiment, a fiber optic termini is utilized that may function as either a pin or socket fiber optic termini. In this case, such fiber optic termini is considered hermaphroditic, and may used as either a pin or socket terminal. Alternatively, a fiber optic pin terminal and a fiber optic pin termini may be constructed differently.

In general terms, at least one embodiment of the present invention is directed to the construction of a hybrid insert cap (pin-style or socket-style) in a blank or universal configuration for use in electrical/fiber optic connectors and assemblies. The insert cap is molded and/or machined into a fixed intermediate configuration (or “blank”) having a plurality of sections. Each section has at least two corresponding bores extending into the body of the insert cap on opposite sides, but without creating an aperture or hole therethrough. Depending on the final desired configuration of the hybrid connector, in one or more subsequent processes, material is removed from the sections of the insert cap body to create an aperture therethrough and having a specific structure. Depending on the resulting specific structure of the section, it is operable for receiving either a fiber optic terminal or electrical terminal. In this manner, a universal hybrid insert cap may be processed/formed into a specific hybrid insert cap having a desired number and pattern of electrical and fiber optic terminals (and blank or dummy terminals, for later use, if desired).

In a first fixed state (referred to as universal or blank), the blank insert caps 108a, 108b provide the stock component part that is used to produce any one of a variety of custom configured insert caps (having pins, sockets, blanks). Further processing of the insert caps 108a, 108b produces insert caps in a second fixed state. The present invention provides several benefits over the prior art, including utilization of generic manufacturing processes for blanks, reduction in lead times to produce custom insert caps, and flexibility to expand or modify numbers and types of connections within a connector during design or in the field.

Though not shown in a specific embodiment of the FIGURES, in one embodiment, a pin insert cap 108a includes at least one electrical pin terminal (or contact) positioned within one of the sections 306 (configured as section 306a) and at least one fiber optic pin terminal positioned within another one of the sections 306 (configured as section 306b). The electrical pin terminal is coupled to an electrical cable or conductor while the fiber optic pin terminal is coupled to a fiber optic cable or conductor. In another embodiment, one or more sections 306 (configured as a blank section 306) of the pin insert cap 108a may exist without any terminals therein.

Similarly, in one embodiment, a socket insert cap 108b includes at least one electrical socket terminal (or contact) positioned within one of the sections 506 (configured as section 506a) and at least one fiber optic socket terminal positioned within another one of the sections 506 (configured as section 506b). The electrical socket terminal is coupled to an electrical cable or conductor while the fiber optic socket terminal is coupled to a fiber optic cable or conductor. In another embodiment, one or more sections 506 (configured as a blank section 506) of the socket insert cap 108b may exist without any terminals therein.

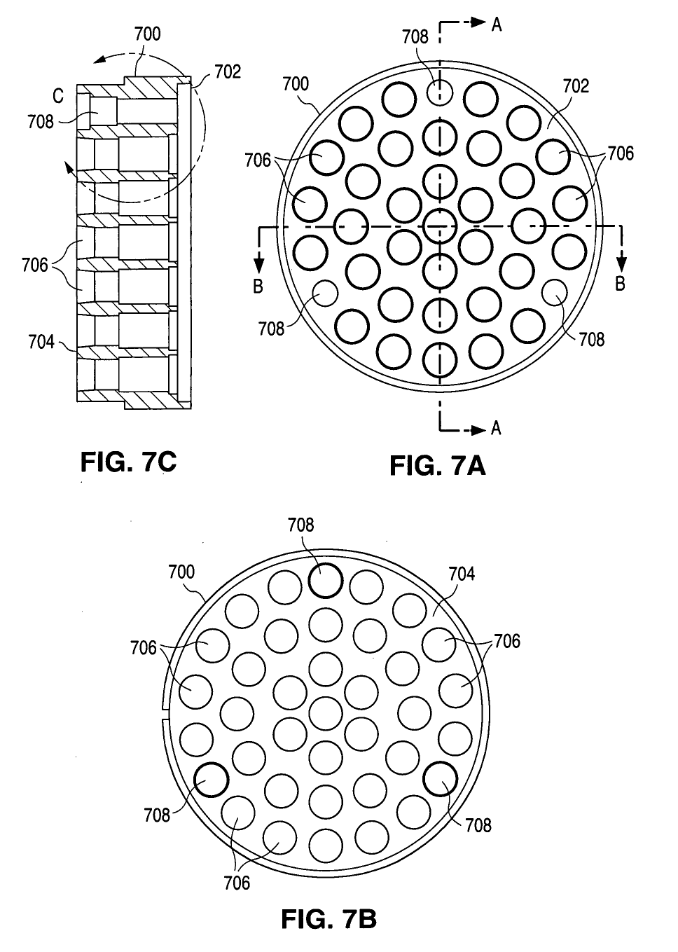

Now referring to FIGS. 7A-7C, there are illustrated various views of an insert body 700. The insert body 700 mates or connects to the insert caps 108a, 108b. In the configuration shown, the insert body 700 is used as an insert body with either the pin-style insert cap 108a or the socket-style insert cap 108b.

With reference to these FIGURES, the insert body 700 includes a first surface 702 and a second surface 704. FIGS. 7A and 7B are front views of the first surface 702 and the second surface 704, respectively, of the insert body 700. FIG. 7C is a cross-sectional view taken along line A-A of FIG. 7A.

The insert body 700 includes a plurality of apertures or holes 706 therethrough. In one embodiment, the configuration and number of the apertures 706 correspond to the configuration and number of the sections 306 or 506 of the insert caps 108a or 108b, respectively. The combination of the insert cap 108 and the insert body 700 form a two-piece insert that houses the electrical and fiber optic terminals. A gasket (not shown) may be placed between the insert body 700 and the insert cap 108.

The insert body 700 further includes one or more holes or apertures 708 for receiving a connector or connection mechanism (e.g., screw) therethrough for connecting or attaching the insert body 700 to the insert cap 108, and possibly to another structure or component, such as a seal or seal housing (described further below).

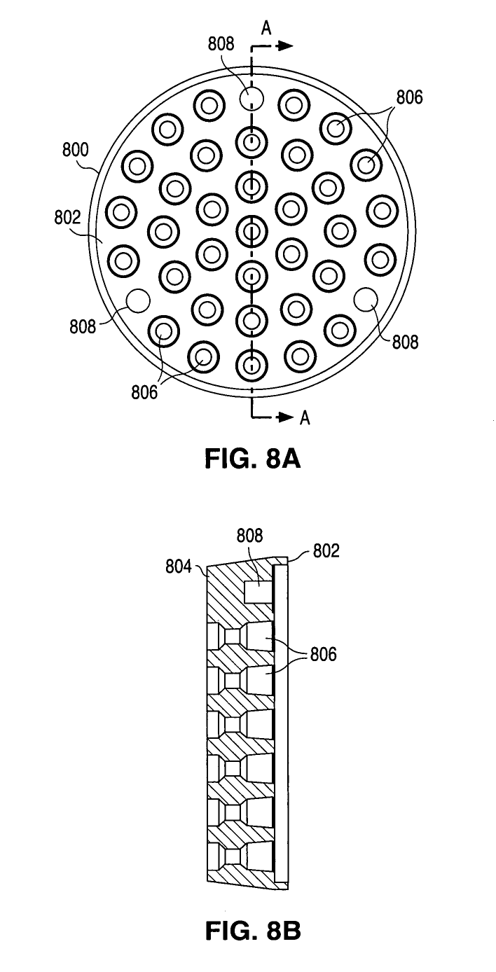

Now referring to FIGS. 8A-8B, there are illustrated two views of a rear seal housing 800. The rear seal housing 800 mates or connects to the insert body 700. In the configuration shown, the rear seal housing 800 is used to seal the terminals within the overall connector insert (i.e., insert cap 108, insert body 700 and rear seal housing 800).

With reference to these FIGURES, the rear seal housing 800 includes a first surface 802 and a second surface 804. FIG. 8A is a front view of the first surface 802 of the rear seal housing 800. FIG. 8B is a cross-sectional view taken along line A-A of FIG. 8A.

The rear seal housing 800 includes a plurality of apertures or holes 806 therethrough. In one embodiment, the configuration and number of the apertures 806 correspond to the configuration and number of the sections 306 or 506 of the insert caps 108a or 108b, respectively. The combination of the insert cap 108, the insert body 700 and the rear seal housing 800 form a three-piece insert housing that seals and houses the electrical and fiber optic terminals. A gasket (not shown) may be placed between the rear seal housing 800 and the insert body 700.

The rear seal housing 800 further includes one or more recesses or receptacle 808 for receiving a connector or connection mechanism (e.g., screw) therein for connecting or attaching the rear seal housing 800 to the insert body 700. As will be appreciated, in one embodiment, the recesses 808 are threaded and screws are utilized to connect the insert cap 108 (via holes 330, 530) and the insert body 700 (via holes 708) to the rear seal housing 800.

The blank insert caps 108a, 108b, as well as the insert body 700 and rear seal housing 800, may be constructed using any conventional manufacturing process, such as by molding or machining, or combination thereof. These components are constructed of insulative material known to those skilled in the art. In one embodiment, the insert caps 108a, 108b are composed of approximately thirty percent (30%) glass filled PEEK material.

Now referring to FIGS. 9A-9B, there is shown an insulative electrical pin insert seal 900 in perspective view (FIG. 9A) and in a cross-sectional view (FIG. 9B). After (or before) an electrical pin terminal is placed within the section 306 (configured as section 306b) of the pin insert cap 108a, insert seal 900 is fixed within the bore 314. The insert seal 900 is donut-shaped, and includes a seal protrusion 902 formed such that when a pin insert cap 108a is mated with a socket insert cap 108b, the seal protrusion 902 seals or engages with the corresponding chamfered portion of bore 526 (see section 506a, FIG. 5B). This provides not only an environmentally secure sealing of the electrical pin/socket connection, it also reduces electromagnetic waves that may emanate from signals carried on connection. The insert seal 900 surrounds partially or completely the electrical contact pin for insulative purposes.

In one embodiment, the insert seal 900 is constructed of a compressible material. In one embodiment, the compressible material is rubber, plastic material, and may be Silastic M—RTV without or without additives. The insert seal 900 may be affixed or positioned within the bore 314 by means and methods known to those skilled in the art. Adhesives and epoxies may be used to bond the seal, which may include thermal heating and/or pressure. A number of other fabrication, preparation and assembly products, and various combinations thereof, as known to those skilled in the art, may all be used in accordance with the present invention.

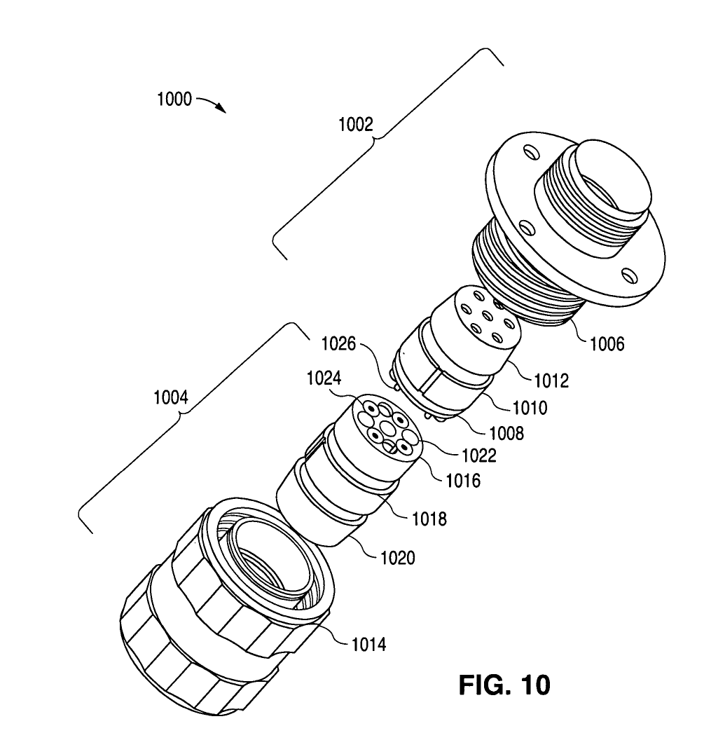

Now referring to FIG. 10, there is shown one embodiment of a complete connection assembly 1000 (male connector and female connector) in accordance with the present invention. Connector assembly 1000 includes a receptacle portion 1002 (socket/female connector) and a plug portion 1004 (pin/male connector). The receptacle portion 1002 includes a housing 1006 through which cable elements (not shown) are brought into secure engagement with a hybrid pin/male insert cap 1008 (same or similar to pin insert cap 108a). The receptacle portion 1002 also includes an insert body 1010 (same or similar to insert body 700), which is provided to retain the insert cap 1008, and facilitate its fixation within the housing 1006. The receptacle portion 1002 may also include a rear seal 1012 (same or similar to the rear seal housing 800), which is provided to facilitate stabilization and securing of the cable elements within the housing 1006.

Similarly, the plug portion 1004 includes a housing 1014 through which cable elements (not shown) are brought into secure engagement with a socket/female insert cap 1016 (same or similar to socket insert cap 108b). The receptacle portion 1004 further includes an insert body 1018 (same or similar to the insert body 700), which is provided to retain the insert cap 1016, and facilitate its fixation within the housing 1014. A rear seal 1020 (same or similar to rear seal housing 800) may also be included that is provided to facilitate stabilization and securing of the cable elements within the housing 1016.

Though not shown in detail, the socket insert cap 1016 includes the plurality of adjacent sections 506, with each section configured as either a blank section (section 506) having no terminal therein, as an electrical socket terminal section (section 506a) having an electrical socket terminal therein, or as a fiber optic socket terminal section (section 506b) having a fiber optic socket terminal therein. Similarly, the pin insert cap 10008 includes the plurality of adjacent sections 306, with each section configured as either a blank section (section 306) having no terminal therein, as an electrical pin terminal section (section 306a) having an electrical pin terminal therein, or as a fiber optic pin terminal section (section 306b) having a fiber optic pin terminal therein.

As housings 1006 and 1014 are brought together and secured, pin terminals 1026 (not shown) in pin insert cap 1008 are engaged with corresponding connections in socket terminals 1024 in socket insert cap 1016. The insert caps 1008 and 1016 may be utilized as shown, or may be switched within the portions 1002, 1004.

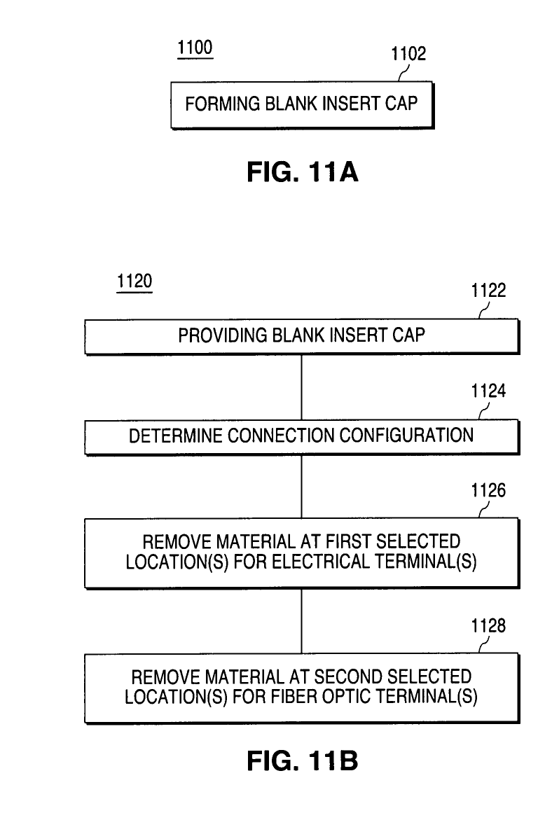

Now referring to FIGS. 11A and 11B, there are illustrated a method or process 1100 for manufacturing a blank insert cap 108a, 108b and a method or process 1120 for manufacturing a custom hybrid insert cap 108a, 108b, in accordance with the teachings herein.

The method 1100 includes forming a blank insert cap (either pin-style 108a or socket-style 108b) having a body, a first side and a second side, at a step 1102. The insert cap 108 further includes a plurality of adjacent sections, each section including a portion of the body and including a first bore or cavity extending from the first side to a predetermined depth in the body, and a second bore or cavity extending from the second side to a predetermined depth in the body. In one embodiment, no passage or holes exist between the respective first bores and second bores. The blank insert cap may be formed from a single uniform piece of material and machined to the desired structure (as described). Alternatively, the blank insert cap may be molded into the desired structure. Other methods of manufacturing may be employed.

In this method, the blank or universal insert caps 108a, 108b are manufactured to include a plurality of connection sections. The structure of the sections is such that they may be further modified by a subtractive method (simply removing material) that customizes the sections to accept a specific terminal type/configuration (e.g., electrical or fiber optic pins/sockets). In other words, the insert caps are partially manufactured into a configuration that is generic or universal. Thus, the insert caps are pre-manufactured to a generic device, and then are further processed to meet a predetermined configuration, such as determined by a customer's needs or application.

The method 1120 for manufacturing a custom hybrid insert cap begins at a step 1122, where a blank insert cap 108 is provided. The blank insert cap 108 may be a pin-style insert cap 108a or a socket-style insert cap 108b. The structure of the blank insert caps 108a, 108b have been described previously. At a step 1124, a connection configuration is determined for given insert cap. This generally includes the determining the number and type of connections desired (i.e., the number of electrical and fiber optic connections, as well as the pattern/positioning of such connections in the insert cap).

Once the configuration is determined, at a step 1126, the insert cap is modified (or further processed) by removing material at one or more selected locations to produce one or more receptacle(s) each having a passage therethrough and having a structure operable for receiving an electrical pin/socket terminal. Similarly, at a step 1128, material is removed from the insert cap at one or more selected locations to produce one or more receptacle(s) each having a passage therethrough and having a structure operable for receiving a fiber optic pin/socket terminal. Additional or further details of these or other steps in the process for manufacturing the custom cap inserts 108a, 108b can be found throughout this document.

The terms “terminus”, “termini” and “terminal” may be used interchangeably herein, and each refers to the end connection or terminal (and may be configured as either a pin/male or socket/female)) of an electrical or fiber optic cable or conductor, without limitation. If specifically intended to refer to electrical or fiber optic, the terms “electrical” or “fiber optic” will be used as a modifier to the terms “terminus”, “termini” or “terminal”.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A multichannel hybrid connector insert cap comprising:
a first end having a surface;
a second end having a surface; and
a body comprising insulative material and having a plurality of sections, each section configured with at least one dimensional aspect operable for receiving a portion of an electrical terminal and at least one dimensional aspect operable for receiving a portion of a fiber optic terminus, and wherein each section is configurable to receive the electrical terminal when a first predetermined amount of material is removed from the section or receive the fiber optic terminus when a second predetermined amount of material is removed from the section.

2. The insert cap in accordance with claim 1 wherein each section further comprises:
a first bore extending from the surface of the first end into the body;
a second bore extending from the surface of the second end into the body; and
wherein the first bore and the second bore are aligned along a longitudinal axis of the section extending from the first end to the second end.

3. The insert cap in accordance with claim 2 wherein there initially exists no passage between the first bore and the second bore.

4. The insert cap in accordance with claim 1 wherein the electrical terminal is an electrical pin terminal.

5. The insert cap in accordance with claim 1 wherein the electrical terminal is an electrical socket terminal.

6. A hybrid connector insert cap comprising:
a first side;
a second side; and
a body, the body comprising a plurality of portions, wherein each portion has initially a universal structure operable for receiving an electrical terminal when a first predetermined amount of material is subsequently removed from the portion and to receive a fiber optic terminal when a second predetermined amount of material is subsequently removed from the portion.

7. A connector comprising:
a connector housing; and
an insert cap positioned within the connector housing, the insert cap comprising,
a plurality of terminal sections,
a first terminal positioned within a first one of the plurality of terminal sections, wherein the first terminal is coupled to a first conductor,
a second terminal positioned within a second one of the plurality of terminal sections, wherein the second terminal is coupled to a second conductor, and
wherein a third one of the plurality of terminal sections is configured as a universal terminal section and does not include a terminal therein.

8. The insert cap in accordance with claim 7 wherein the first terminal is an electrical terminal and the second terminal is a fiber optic terminal.

9. The connector in accordance with claim 8 wherein the insert cap is a pin-style insert cap and the electrical terminal is an electrical pin terminal.

10. The connector in accordance with claim 8 wherein the insert cap is a socket-style insert cap and the electrical terminal is an electrical socket terminal.

11. A method of forming a blank or universal insert cap for use in a multichannel connector, the method comprising:
forming the universal insert cap including a body, a first end having a surface and a second end having a surface, wherein the body comprises insulative material and a plurality of sections, each section configured with at least one dimensional aspect operable for receiving a portion of an electrical terminal and at least one dimensional aspect operable for receiving a portion of a fiber optic terminus, and wherein each section is configurable to receive the electrical terminal when a first predetermined amount of material is removed from the section or receive the fiber optic terminus when a second predetermined amount of material is removed from the section.

12. The method in accordance with claim 11 further comprising:
forming a first bore extending from the surface of the first end into the body;
forming a second bore extending from the surface of the second end into the body; and
wherein the first bore and the second bore are aligned along a longitudinal axis of the section extending from the first end to the second end.

13. The method in accordance with claim 12 wherein there initially exists no passage between the first bore and the second bore.

14. A method of forming a custom hybrid insert cap from a blank or universal insert cap for use in a connector, the method comprising:
providing a blank insert cap having a plurality of terminal sections;
determining a connector configuration for the custom hybrid insert cap;
removing material from one or more selected first terminal sections to form one or more electrical terminal receptacles operable for receiving one or more electrical terminals based on the determined connector configuration; and
removing material from one or more selected second terminal sections to form one or more fiber optic terminal receptacles operable for receiving fiber optic terminals based on the determined connector configuration.

15. The method in accordance with claim 14 wherein the one or more electrical terminal receptacles have a first configuration and the one or more fiber optic terminal receptacles have a second configuration.
